(19) United States
(12) Patent Application Publication
(10) Pub. No.: US 2015/0346877 A1
(43) Pub. Date: Dec. 3, 2015

(54) WEARABLE ELECTRONIC DEVICE

(71) Applicant: Microsoft Corporation, Redmond, WA (US)

(72) Inventors: Gregory Kim Justice, Redmond, WA (US); Kok Liang Yue, Sammamish, WA (US); Vinod L. Hingorani, Redmond, WA (US); Adam Hewko, Kirkland, WA (US)

(21) Appl. No.: 14/292,106

(22) Filed: May 30, 2014

(51) Int. Cl. G06F 3/047; G09G 5/00

(52) U.S. Cl. CPC G06F 3/047; G09G 5/003; G09G 2300/04

(57) ABSTRACT

Examples of wearable electronic devices are disclosed. For example, one disclosed embodiment provides a wearable electronic device comprising a band and a touch display module coupled to the band. The touch display module comprises a glass display cover incorporated in a molded polymer outer shell as an insert, and the molded polymer outer shell comprises one or more curved surfaces. The touch display module also comprises a touch sensor laminated to a backside of the glass display cover, and a display laminated to a backside of the touch sensor.

### BACKGROUND

Mobile electronic devices may take various forms. For example, some mobile electronic devices, such as a smart phone, may be configured to be carried by a user. Others may be configured to be worn on a body part.

### BRIEF DESCRIPTION OF THE DRAWINGS

FIGS. 1A and 1B show views of an example wearable electronic device.

FIG. 2 shows an exploded view of an example touch display module of the wearable electronic device of FIGS. 1A-1B.

FIG. 3 shows a front perspective view of an example molded polymer outer shell having a glass insert.

FIG. 4 shows a rear perspective view of the outer shell structure of FIG. 3, and illustrates examples of a touch sensor, a display, and flexible circuits providing electrical connections thereto.

FIG. 5 shows a block diagram of an embodiment of an electronic device.

### DETAILED DESCRIPTION

Wearable electronic devices may be subject to various design constraints compared to non-wearable electronic devices. For example, a wearable electronic device may be exposed to water, sweat, impact, shock, vibration, etc. to a greater degree than non-wearable electronic devices. Further, aspects such as appearance, comfort, and size, while considerations in the design of any mobile device, may be even stronger drivers of design with a wearable device.

As a more specific example, a wearable computing device configured to be worn on a user's wrist may be exposed to a relatively large amount of motion, and may experience impacts and shocks more regularly than a non-wearable mobile device, due to its presence on a user's wrist even when the user is not directly engaged with use of the device. The device also may be exposed to moisture as a user exercises, washes hands, etc. Further, due to the device being wearable, market factors may dictate that solutions to such issues maintain desirable fashion and fit characteristics.

Accordingly, implementations of wearable electronic devices are disclosed herein that may help to protect from water ingress, provide resistance to impact, shock and vibration events, and yet maintain a thin, narrow and elegant profile in a region of a touch sensitive display. An exemplary wearable electronic device comprises a band and a touch display module coupled to the band. The touch display module comprises a glass display cover incorporated in a molded polymer outer shell as an insert, the molded polymer outer shell comprising one or more curved surfaces. The touch display module also comprises a touch sensor laminated to a backside of the glass display cover, and a display laminated to a backside of the touch sensor.

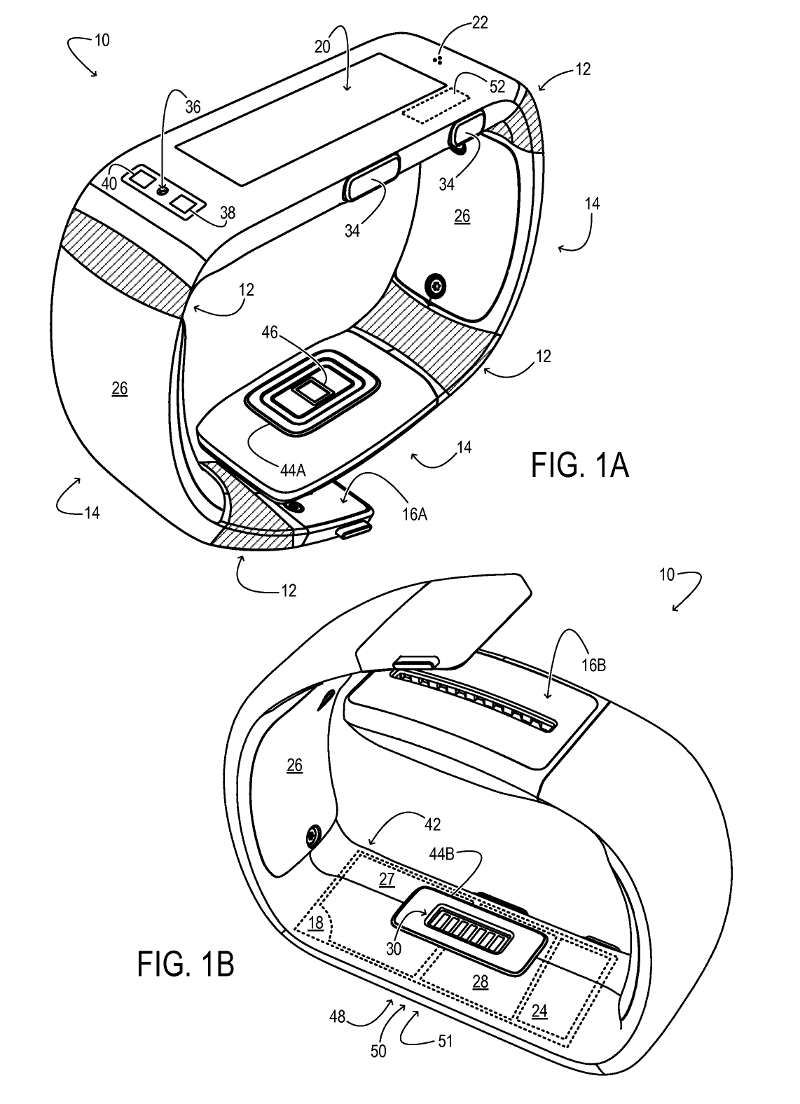

FIGS. 1A and 1B show aspects of an example wearable electronic device 10. The illustrated device is band-shaped, with at least four flexion regions 12 linking less flexible regions 14. The flexion regions may be elastomeric in some examples. Fastening componentry 16A and 16B is arranged at both ends of the device. The flexion regions and fastening componentry enable the device to be closed into a loop and to be worn on a user's wrist. In related implementations, wearable electronic devices of a more elongate band shape may be worn around the user's bicep, waist, chest, or other body part.

Wearable electronic device 10 includes various functional components integrated into regions 14. For example, the electronic device includes a computing system 18, touch display module 20, loudspeaker 22, communication suite 24, and various sensors. These components draw power from one or more energy storage cells 26. A battery, such as a lithium ion battery, is one type of energy storage cell suitable for this purpose. Examples of other suitable energy storage cells include super- and ultra-capacitors. In devices worn on the user's wrist, the energy storage cells may be curved to fit the wrist, as shown in the drawings.

Energy storage cells 26 may be replaceable and/or rechargeable. In some examples, recharge power may be provided through a universal serial bus (USB) port 30, which includes a magnetic latch to releasably secure a complementary USB connector. In other examples, the energy storage cells may be recharged by wireless inductive or ambient-light charging. In still other examples, the wearable electronic device may include electro-mechanical componentry to recharge the energy storage cells from the user's adventitious or purposeful body motion. For example, batteries or capacitors may be charged via an electromechanical generator integrated into device 10. The generator may be turned by a mechanical armature that turns while the user is moving and wearing device 10.

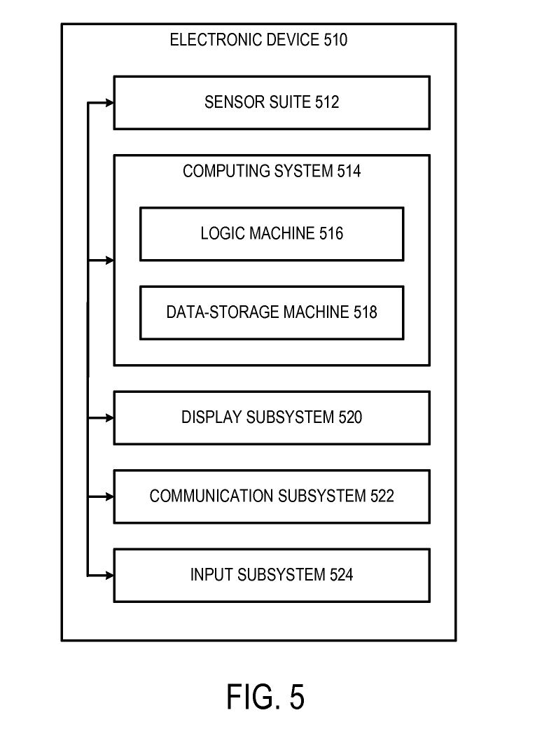

In wearable electronic device 10, computing system 18 is situated below touch display module 20 and operatively coupled to the display, along with loudspeaker 22, communication suite 24, and the various sensors. Computing system 18 includes a data-storage machine 27 to hold data and instructions, and a logic machine 28 to execute the instructions. Aspects of the computing system are described in further detail with reference to FIG. 5.

Touch display module 20 include a touch sensor and a display, as described in more detail below. Touch display module 20 may include any suitable type of display. In some configurations, a thin, low-power light emitting diode (LED) array or a liquid-crystal display (LCD) array may be used. An LCD array may be backlit in some implementations. In other implementations, a reflective LCD array (e.g., a liquid crystal on silicon, LCOS array) may be frontlit via ambient light. Likewise, touch display module 20 may utilize any suitable type of touch sensor, including but not limited to resistive, capacitive, or optical touch sensing mechanisms. Pushbutton sensors may be used to detect the state of push buttons 34, which may include rockers. Input from the pushbutton sensors may be used to enact a home-key or on-off feature, control audio volume, turn the microphone on or off, or any other function.

Communication suite 24 may include any suitable wired or wireless communications componentry. In FIGS. 1A and 1B, the communications suite includes USB port 30, which may be used for exchanging data between wearable electronic device 10 and other computer systems, as well as providing recharge power. The communication suite may further include Bluetooth, Wi-Fi, cellular, near-field communication radios, and/or other radios. In some implementations, the communication suite may include an additional transceiver for optical, line-of-sight (e.g., infrared) communication.

FIGS. 1A and 1B show various other sensors of wearable electronic device 10. Such sensors include microphone 36, visible-light sensor 38, ultraviolet sensor 40, and ambient temperature sensor 42. The microphone provides input to computing system 18 that may be used to measure the ambient sound level or receive voice commands from the wearer. Input from the visible-light sensor, ultraviolet sensor, and ambient temperature sensor may be used to assess aspects of the wearer's environment, such as the temperature, overall lighting level, and whether the wearer is indoors or outdoors.

FIGS. 1A and 1B also show a pair of contact sensor modules 44A and 44B, which contact the wearer's skin when wearable electronic device 10 is worn. The contact sensor modules may include independent or cooperating sensor elements, to provide a plurality of sensory functions. For example, the contact sensor modules may provide an electrical resistance and/or capacitance sensory function, which measures the electrical resistance and/or capacitance of the wearer's skin. Computing system 18 may use such input to assess whether or not the device is being worn, for instance. In some implementations, the sensory function may be used to determine how tightly the wearable electronic device is being worn. In the illustrated configuration, the separation between the two contact-sensor modules provides a relatively long electrical path length that may provide more accurate measurement of skin resistance. In some examples, a contact sensor module may also provide measurement of the wearer's skin temperature. Arranged inside contact sensor module 44B in the illustrated configuration is an optical pulse rate sensor 46. The optical pulse-rate sensor may include an LED emitter and matched photodiode to detect blood flow through the capillaries in the skin and thereby provide a measurement of the wearer's pulse rate.

Wearable electronic device 10 may also include motion sensing componentry, such as an accelerometer 48, gyroscope 50, and magnetometer 51. The accelerometer and gyroscope may furnish inertial data along three orthogonal axes as well as rotational data about the three axes, for a combined six degrees of freedom. This sensory data can be used to provide a pedometer/calorie-counting function, for example. Data from the accelerometer and gyroscope may be combined with geomagnetic data from the magnetometer to further define the inertial and rotational data in terms of geographic orientation. The wearable electronic device may also include a global positioning system (GPS) receiver 52 for determining the wearer's geographic location and/or velocity. In some configurations, the antenna of the GPS receiver may be relatively flexible and extend into flexion regions 12.

Computing system 18, via the sensory functions described herein, is configured to acquire various forms of information about the wearer of wearable electronic device 10. Such information must be acquired and used with utmost respect for the wearer's privacy. Accordingly, the sensory functions may be enacted subject to opt-in participation of the wearer. In implementations where personal data is collected on the device and transmitted to a remote system for processing, that data can be anonymized. In other examples, personal data may be confined to the wearable electronic device, and only non-personal, summary data transmitted to the remote system.

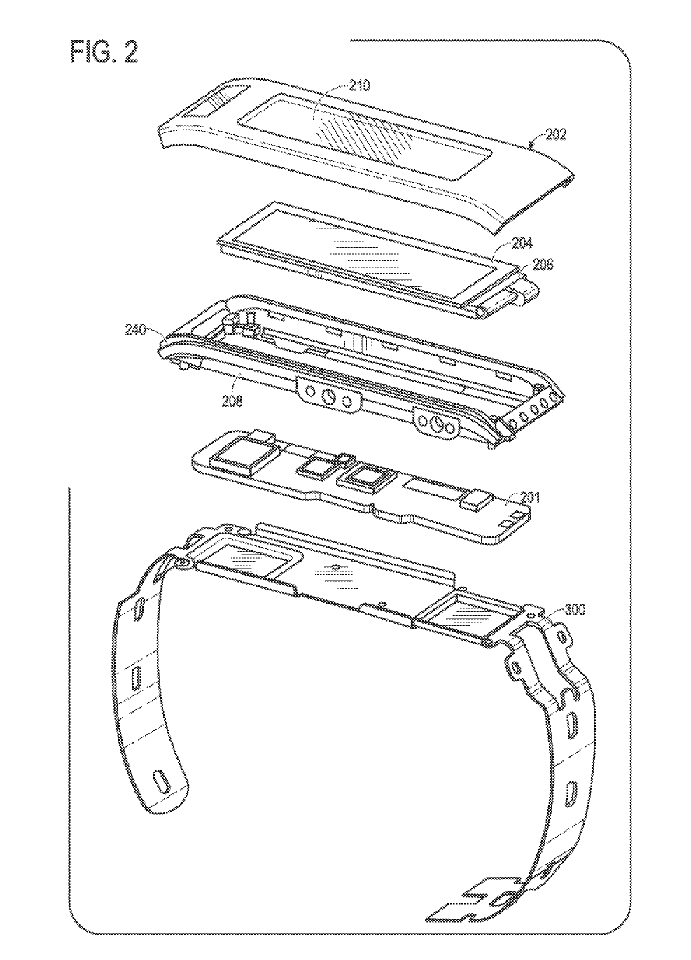

FIG. 2 shows an exploded view of the touch display module 20, and also illustrates other components to which the touch display module 20 may connect mechanically and electrically, including a band backbone 200 and main printed circuit assembly 201. The depicted touch display module 20 includes an outer shell 202, a touch sensor 204, a display device 206, and a frame 208.

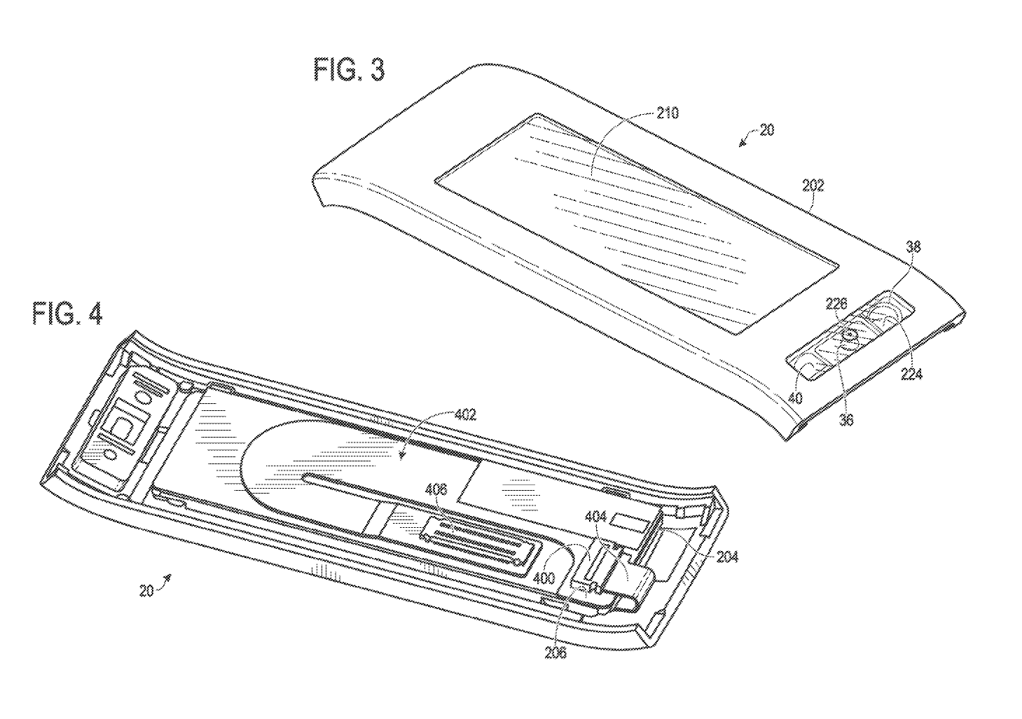

The outer shell 202 is configured to have a curved shape that follows a general shape of a wrist and other contours of the overall design of the wearable electronic device 10. This may help to maintain a low device profile around an entirety of a user's wrist when the device is worn. FIG. 3 shows the outer shell 202 in more detail. The outer shell 202 incorporates a display window 210 through which the display may be viewed. The display window 210 may take any suitable form and may be incorporated into the outer shell 202 in any suitable manner. As one example, the display window 210 may comprise a planar glass sheet that is insert molded into the outer shell 202 in an injection molding process, wherein insert molding refers to a process in which an insert (e.g. the glass of the display window) is placed in a mold prior to injecting a moldable material into the mold, such that the insert is incorporated into the molded product as the molding material hardens in the mold.

The glass of the display window 210 may include features designed to help the glass attach more securely to the plastic during the insert molding process. For example, the glass may have specially ground edges, and/or features that allow the glass to mechanically engage the hardened polymer of the outer shell 202. The glass of the display window 210 also may have tooling features that facilitate the insert molding process, e.g. to hold the glass firmly in the mold during injection of the polymer material from which the outer shell 202 is formed. While disclosed herein as comprising a glass sheet, it will be understood that the display window 210 may be made from any other material. Further, in other embodiments, the outer shell may be formed from curved glass, rather than planar glass molded into a curved outer shell. Additionally, it will be understood that the display window may be coupled to the outer shell by mechanisms other than insert molding. For example, the display window may be attached to the outer shell by a suitable adhesive after molding of the outer shell.

The touch display module 20 may also have other features. For example, the outer shell 202 may include a sensor window 220 configured to accommodate one or more environmental sensors, such as the previously-mentioned microphone 36, visible light sensor 38, and ultraviolet light sensor 40. The sensor window 220 may be made of a material that is at least partially transparent to wavelengths of light sensed by the visible light sensor 222 and the ultraviolet light sensor 224 so that light of the sensed wavelengths may reaches the intended sensors. As one non-limiting environment, the sensor window 220 may be formed from poly(methyl methacrylate) (PMMA). Further, in some implementations, the sensor window may include a layer of colorant (e.g. a dye- or pigment-based ink) formed over at least a portion of the sensor window that allows the visible light sensor and/or the ultraviolet light sensor to view the external environment through the layer of ink while concealing the sensor or sensors from a user's view. Such a layer of colorant may be sufficiently thin and/or may include small unprinted areas configured to pass light to the sensors, and may have any suitable appearance.

The sensor window 220 further may include an opening to pass sounds to the microphone 36. The depicted embodiment includes a small hole 226 as a microphone interface, but it will be appreciated that any suitable number of openings of any suitable size(s) and/or shape(s) may be used.

The sensor window 220 may be incorporated into the outer shell 202 in any suitable manner. For example, in some embodiments, the sensor window 220 may be insert molded into the outer shell along with the display window 210. In other embodiments, the sensor window may be attached (for example, via adhesive) after molding of the outer shell.

The touch sensor 204 and display device 206 are positioned beneath the display window 210 to display content and receive touch inputs. The touch sensor 204 and display device 206 may be incorporated into the wearable electronic device 10 in any suitable manner. As one non-limiting example, one side of the touch sensor 204 may be coupled to an inner surface of the display window 220 with an optically clear adhesive, and the display device 206 may be coupled to the other side of the touch sensor 204 with an optically clear adhesive to form a touch sensor/display stack. In one more specific example, the touch sensor may comprise an indium tin oxide (ITO) based sensor bonded to the display window 220 and to a backlit liquid crystal display (LCD) via optically clear adhesive. While the touch sensor 204 is depicted as being located between the display window 220 and the display device 206, in other implementations the display device may be adhered to the display window and the touch sensor may be located behind the display device relative to the display window, depending upon the display and touch sensing technologies utilized.

The touch sensor 204 and display device 206 may be coupled electrically and mechanically to other structures of the wearable electronic device 10 in any suitable manner. FIG. 4 illustrates non-limiting examples of electrical connections. A first electrical connector 400 located at a first end of a first flexible circuit 402 is connected to the display device 206, and also to the touch sensor 204 via a second flexible circuit 404. The first flexible circuit 402 acts as a direct communication path between the main printed circuit assembly 201 and the display, while the second flexible circuit piggybacks on the first flexible circuit to carry communications between the touch sensor and the main printed circuit assembly 201.

The first flexible circuit 402 extends along the backside of the touch display module 20 in an elongate configuration, and terminates in a second end having a second electrical connector 406 configured to connect to other circuitry, such as the main circuit assembly 201 depicted in FIG. 2. The use of an elongate first flexible circuit may allow the second electrical connector 406 to be moved away from the backside of the touch display module when being connected to other circuitry. This may simplify device assembly, as the second connector may be connected to other circuitry before the touch display module 20 is connected mechanically to other portions of the wearable electronic device 10. The second flexible circuit 408 has a shorter length than the first, and is configured to extend sufficiently far to facilitate connecting to the first electrical connector 400 and the touch sensor 204, yet to be short enough to fit within the narrow and thin form of the touch display module.

In the depicted example, the first flexible circuit 402 comprises an elongate shape that extends in a first direction from the first end, and then curves and extends in a second direction toward the second end to form a U-shaped loop. Such a shape may allow a relatively long flexible circuit to be fit within the narrow, thin form factor of the touch display module 20 without increasing a thickness or width of the touch display module. In other implementations, the first flexible circuit may have any other suitable shape, such as an accordion-like configuration that folds upon itself, a coiled configuration, a zig zag configuration, or other configuration that permits the flexible circuit to extend and collapse into a tight storage space. In the depicted embodiment the first flexible circuit attaches directly to the display device 206, and connects to the touch sensor 204 via the second flexible circuit 408.

The touch display module 20 may be mechanically connected to other parts of the wearable electronic device 10 in any suitable manner. As one non-limiting example, and referring again to FIG. 2, frame 208 may be configured to connect mechanically (e.g. via fasteners and/or other mechanical features) to the band backbone. The frame 208 may be formed from a metal material (e.g. steel) or other suitable material, and may include a plastic overmolding 240. The plastic overmolding 240 may be bonded to the outer shell 202 of the touch display module 20 to thereby connect the touch display module 20 to the band backbone 200. This may help to form a watertight seal around the touch display module 20 and printed circuit assembly 201, as well as to provide an attractive appearance.

The frame 208 also may help to protect the touch display module from impacts, bending, and twisting movements. For example, the aspect ratio of the display device of the wearable electronic device 10 may be longer and narrower than other displays. This may increase a susceptibility to damage by twisting motions, as well as to bending motions along a long direction of the display, compared to displays with a relatively less narrow configuration. As such, the use of the frame 208 may help to provide additional mechanical strength to the display. Further, as mentioned above, the use of the above-described elongate first flexible circuit 402 may allow the second electrical connector 406 to be connected to the main printed circuit assembly 201 prior to adhering the plastic overmolding 240 of the frame 208 with the outer shell 202, which may simplify manufacturing.

After attachment of the frame 208 to the band backbone 200, the combined structure may be overmolded with a suitable material, such as a thermoplastic polymer, to seal the device and provide the device with a unitary appearance. The resulting wearable electronic device may protect the touch display module from water, impact, shock and vibration, and yet provide a thin, narrow and attractive appearance in a region that includes the touch display module.

The examples described above may be utilized on any other suitable FIG. 5 shows a block diagram of an electronic device 510 that may represent wearable electronic device 10, or any other suitable electronic device incorporating one or more of the features described above. Electronic device 510 comprises a sensor suite 512 operatively coupled to a computing system 514. The computing system includes a logic machine 516 and a data-storage machine 518. The computing system is also operatively coupled to a display subsystem 520, a communication subsystem 522, an input subsystem 524, and/or other components not shown in FIG. 5.

Logic machine 516 includes one or more physical devices configured to execute instructions. The logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic machine 516 may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of a logic machine optionally may be distributed among two or more separate devices, which may be remotely located and/or configured for coordinated processing. Aspects of a logic machine may be virtualized and executed by remotely accessible, networked computing devices in a cloud-computing configuration.

Data-storage machine 518 includes one or more physical devices configured to hold instructions executable by logic machine 516 to implement the methods and processes described herein. When such methods and processes are implemented, the state of the data-storage machine may be transformed—e.g., to hold different data. The data-storage machine may include removable and/or built-in devices; it may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The data-storage machine may include volatile, nonvolatile, dynamic, static, read/write, read-only, random-access, sequential-access, location-addressable, file-addressable, and/or content-addressable devices.

It will be appreciated that data-storage machine 518 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 516 and data-storage machine 518 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

Display subsystem 520 may be used to present a visual representation of data held by data-storage machine 518. This visual representation may take the form of a graphical user interface (GUI). As the herein described methods and processes change the data held by the storage machine, and thus transform the state of the storage machine, the state of display subsystem 520 may likewise be transformed to visually represent changes in the underlying data. Display subsystem 520 may include one or more display subsystem devices utilizing virtually any type of technology. Such display subsystem devices may be combined with logic machine 516 and/or data-storage machine 518 in a shared enclosure, or such display subsystem devices may be peripheral display subsystem devices. Display device 206 FIG. 2 is an example of display subsystem 520.

Communication subsystem 522 may be configured to communicatively couple computing system 514 to one or more other computing devices. The communication subsystem may include wired and/or wireless communication devices compatible with one or more different communication protocols. As non-limiting examples, the communication subsystem may be configured for communication via a wireless telephone network, a local- or wide-area network, and/or the Internet. Communication suite 24 of FIGS. 1A and 1B is an example of communication subsystem 522.

Input subsystem 524 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity. Touch sensor 204 of FIG. 2 and push buttons 34 of FIGS. 1A and 1B are examples of input subsystem 524.

Sensor suite 512 may include one or more different sensors—e.g., a touch-screen sensor, push-button sensor, microphone, visible-light sensor, ultraviolet sensor, ambient-temperature sensor, contact sensors, optical pulse-rate sensor, accelerometer, gyroscope, magnetometer, and/or GPS receiver—as described above with reference to FIGS. 1A and 1B.

It will be understood that the configurations and approaches described herein are exemplary in nature, and that these specific implementations or examples are not to be taken in a limiting sense, because numerous variations are feasible. The specific routines or methods described herein may represent one or more processing strategies. As such, various acts shown or described may be performed in the sequence shown or described, in other sequences, in parallel, or omitted.

The subject matter of this disclosure includes all novel and non-obvious combinations and sub-combinations of the various processes, systems and configurations, and other features, functions, acts, and/or properties disclosed herein, as well as any and all equivalents thereof.

1. A wearable electronic device, comprising:
a band; and
a touch display module coupled to the band, the touch display module comprising:
a glass display window incorporated in a molded polymer outer shell as an insert, the molded polymer outer shell comprising one or more curved surfaces,
a touch sensor laminated to a backside of the glass display cover, and
a display laminated to a backside of the touch sensor.

2. The wearable electronic device of claim 1, further comprising a sensor window molded into the molded polymer outer shell,

3. The wearable electronic device of claim 2, further comprising an ultraviolet light sensor positioned to receive ultraviolet light through the sensor window.

4. The wearable electronic device of claim 2, further comprising a layer of colorant over at least a portion of the window, and a visible light sensor positioned to receive visible light through the layer of colorant.

5. The wearable electronic device of claim 2, further comprising a microphone positioned within the touch display module behind the sensor window, and the wherein the window includes an opening configured to pass sound to the microphone.

6. The wearable electronic device of claim 1, wherein the touch display module comprises a flexible circuit connected at a first end to one or more of the touch sensor and the display, the flexible circuit having an elongate shape that extends along a backside of the touch display module to a second end having a connector configured to connect to other circuitry.

7. The wearable electronic device of claim 6, wherein the flexible circuit extends in a first direction from the first end, and then curves and extends in a second direction toward the second end.

8. The wearable electronic device of claim 1, wherein the glass display cover has a planar configuration.

9. The wearable electronic device of claim 1, wherein the touch sensor is coupled to the glass display cover coupled via an optically clear adhesive, and wherein the display is coupled to the touch sensor via an optically clear adhesive.

10. The wearable electronic device of claim 1, wherein the touch display module further comprises a metal frame and a polymer overmolding disposed on the metal frame, and wherein the polymer outer shell is bonded to the polymer overmolding.

11. The wearable computing device of claim 10, wherein the metal frame is coupled to a metal band within the wearable electronic device.

12. A wearable electronic device, comprising:
a band; and
a touch display module coupled to the band, the touch display module comprising
a outer shell comprising one or more curved surfaces,
a display window coupled to the outer shell as a molded insert,
a sensor window coupled to the touch display module as a molded insert, the sensor window being at least partially transparent to ultraviolet light,
an ultraviolet light sensor positioned to detect ultraviolet light through the sensor window, and
a touch sensor/display stack adhered to a backside of the display window.

13. The wearable electronic device of claim 12, further comprising a visible light sensor positioned to receive light through the sensor window.

14. The wearable electronic device of claim 12, further comprising a microphone positioned within the touch display module behind the sensor window, and the wherein the window includes an opening to pass sound to the microphone.

15. The wearable electronic device of claim 12, wherein the touch display module comprises a flexible circuit connected at a first end to one or more of the touch sensor and the display, the flexible circuit comprising an elongate configuration that extends along a backside of the touch display module to a second end having a connector configured to connect to other circuitry.

16. The wearable electronic device of claim 15, wherein the flexible circuit comprises an elongate shape that extends in a first direction from the first end, and then curves and extends in a second direction toward the second end.

17. The wearable electronic device of claim 12, wherein the touch display module further comprises a metal frame and a polymer overmolding on the metal frame, and wherein the outer shell is bonded to the polymer overmolding.

18. A wearable electronic device, comprising:
a band; and
a touch display module coupled to the band, the touch display module comprising
a display window insert molded into a molded outer shell,
a touch sensor/display stack laminated to a backside of the glass display cover, and
a flexible circuit connected at a first end to one or more of the touch sensor and the display, the flexible circuit extending along a backside of the touch display module in a first direction away from the first end and then in a second direction toward the first end to terminate in a second end having a connector configured to connect to other circuitry.

19. The wearable electronic device of claim 18, wherein the flexible circuit comprises a U-shaped configuration.

20. The wearable electronic device of claim 18, wherein the flexible circuit comprises an elongate shape that extends in a first direction from the first end, and then curves and extends in a second direction toward the second end.
